(19) United States
(12) Patent Application Publication
(10) Pub. No.: US 2013/0320883 A1
(43) Pub. Date: Dec. 5, 2013

(54) DEVICE AND METHOD FOR INTERFACING A DIMMING CONTROL INPUT TO A DIMMABLE LIGHTING DRIVER WITH GALVANIC ISOLATION

(71) Applicant: Sanbao Zheng, Eindoveen (NL)

(72) Inventor: Sanbao Zheng, Eindoveen (NL)

(73) Assignee: KONINKJIKE PHILLIPS N.V., ENDHOVEN (NL)

(21) Appl. No.: 13/982,050

(22) PCT Filed: Jan. 24, 2012
(86) PCT No.: PCT/IB12/50330

§ 371 Date: Aug. 15, 2013

Related U.S. Application Data
(60) Provisional application No. 61/437,724, filed on Jan. 31, 2011.

(51) Int. Cl. H05B 37/02

(52) U.S. Cl. CPC H05B 37/02
USPC 315/307

(57) ABSTRACT

A dimmer interface (110, 300) for a dimmable lighting driver (100) for a lighting unit (20) includes: a pulse width modulator (320, 420, 500) configured to generate a pulse width modulated signal (V2) from a dimming control input (Vdim), where the dimming control input (Vdim) is variable to adjust the brightness of the lighting unit (20); a low-pass filter (444) configured to output a dimming control voltage (Vo); and an optocoupler (330, 4300 configured to galvanically couple the pulse width modulated signal (V2) from an output of the pulse width modulator (320, 420, 500) to an input of the low-pass filter (444).

### TECHNICAL FIELD

The present invention is directed generally to a dimmer interface for a dimmable lighting driver. More particularly, various inventive methods and apparatus disclosed herein relate to a dimmer interface for a dimmable lighting driver, which provides galvanic isolation between a dimming control input and the rest of the dimmable lighting driver that may be exposed to high voltage (e.g., a high voltage output stage and/or power input stage of the dimmable lighting driver, which is not isolated from mains power supply).

### BACKGROUND

In many applications employing a dimmable lighting driver, for example a lighting ballast, galvanic isolation of the dimmer control input from the rest of the dimmable lighting driver that may be exposed to high voltage (e.g., a high voltage output power stage and/or an input power stage of the dimmable lighting driver, which is not isolated from mains power supply) is required by industrial standards such as Underwriters Laboratory (UL) and European Conformity (CE). One common approach to providing this galvanic isolation between the dimmer control input and the rest of the dimmable lighting driver relies on an isolation transformer for the dimmer control input. Such isolation transformer is provided in addition to a main power transformer that may be employed by the lighting driver for isolation between its input power stage and its output power stage. The isolation transformer is excited by a source, usually a square wave, and loaded by an external dimmer which provides a dimming voltage level set by a user.

This arrangement suffers from some disadvantages. The isolation transformer is often big and costly due to the isolation requirements, and the dimming performance can be affected by changes in ambient temperature due to the temperature-dependent characteristics of the transformer core.

Thus, there is a need in the art to provide a dimmable lighting driver, and a dimmer interface for a dimmable lighting driver, which can provide galvanic isolation between a dimmer control input and the rest of the dimmable lighting driver circuit without requiring a transformer for the dimmer control input.

### SUMMARY

The present disclosure is directed to inventive methods and apparatus for a dimmable lighting driver, and for a dimmer interface for a dimmable lighting driver. For example, in various embodiments, the dimmer interface provides galvanic isolation between a dimming control input and the rest of the dimmable lighting driver without requiring a transformer for the dimming control input. This may reduce the size and cost of the dimmer interface, and a dimmable lighting driver that includes the dimmer interface, compared to conventional devices having a transformer for the dimming control input.

Generally, in one aspect, the invention focuses on an electronic device including a dimming voltage generator configured to receive a dimming control input indicating an amount of dimming to be applied to a lighting unit, and being further configured in response to the dimming control input to generate a dimming voltage; a pulse width modulator configured to receive the dimming voltage and in response thereto to generate a pulse width modulated signal having a duty cycle that is varied in response to the dimming voltage; an optocoupler configured to receive the pulse width modulated signal and in response thereto to output an isolated pulse width modulated signal that is galvanically isolated from the dimming voltage generator and the pulse width modulator; a low-pass filter configured to average the isolated pulse width modulated signal and to output a dimming control voltage; and a lighting driver configured to receive the dimming control voltage and input power from an AC power source and in response thereto to supply power to the lighting unit, wherein the power supplied to the lighting unit is varied in response to the dimming control input.

According to one embodiment, the pulse width modulator includes a triangle wave generator configured to generate a triangle wave and a comparator configured to compare the triangle wave and the dimming voltage and to generate the pulse width modulated signal in response to the comparison.

According to another embodiment, the electronic device also includes a buffer amplifier configured to receive the isolated pulse width modulated signal and to buffer the isolated pulse width modulated signal for the low-pass filter, wherein the dimming voltage generator and the pulse width modulator operate with a first supply voltage, and wherein the buffer amplifier operates with a second supply voltage, wherein the first and second supply voltages are galvanically isolated from each other.

Generally, in another aspect, the invention relates to a method including generating a pulse width modulated signal from a dimming control input, where the dimming control input is variable to adjust a brightness of a light source; passing the pulse width modulated signal through an optocoupler; and low-pass filtering an output signal of the optocoupler to produce a dimming control voltage for adjusting the brightness of the light source.

According to one embodiment, the method further includes providing the dimming control voltage to a lighting driver for driving the light source.

According to another embodiment, the step of generating the pulse width modulated signal from the dimming control input includes: generating a dimming voltage in response to the dimming control input; generating a triangle wave; and comparing the dimming voltage to the triangle wave to generate the pulse width modulated signal

Generally, in yet another aspect, the invention relates to an electronic device including a pulse width modulator configured to generate a pulse width modulated signal from a dimming control input, where the dimming control input is variable to adjust a brightness of a light source; a low-pass filter configured to output a dimming control voltage; and an optocoupler configured to couple the pulse width modulated signal from an output of the pulse width modulator to an input of the low-pass filter with galvanic isolation between the pulse width modulator and the low-pass filter.

According to one embodiment, the electronic device is connected to a dimming controller and a lighting driver and provides galvanic isolation between the dimming controller and the lighting driver.

According to another embodiment, the pulse width modulator includes: a dimming voltage generator configured to receive the dimming control input and in response thereto to generate a dimming voltage; a triangle wave generator configured to generate a triangle wave; and a comparator configured to compare the triangle wave and the dimming voltage and to generate the pulse width modulated signal in response to the comparison.

As used herein for purposes of the present disclosure, the term “light source” should be understood to refer to any one or more of a variety of radiation sources, including, but not limited to, LED-based sources (including one or more LEDs), incandescent sources (e.g., filament sources, halogen sources), fluorescent sources, phosphorescent sources, high-intensity discharge sources (e.g., sodium vapor, mercury vapor, and metal halide sources), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum.

The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s).

The term “lamp” should be interpreted to refer to a lighting unit that includes connector(s) for receiving electrical power and for generating radiation (e.g., visible light) from the received electrical power. Examples include bulbs and tubes, including incandescent bulbs, fluorescent bulbs, fluorescent tubes, LED bulbs, LED tubes, etc. The term “lighting fixture” is used herein to refer to an implementation or arrangement of one or more lighting units (e.g., lamps) in a particular form factor, assembly, or package.

The term “lighting driver” is used herein to refer to a circuit which supplies power to a light source to cause the light source to emit light.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

As used herein, “galvanic isolation” refers to the principle of isolating functional sections of electrical systems preventing the moving of charge-carrying particles from one section to another. There is no electric current flowing directly from a first section to a second section when the first and second sections are galvanically isolated from each other. Energy and/or information can still be exchanged between the sections by other means, e.g. capacitance, induction, electromagnetic waves, optical, acoustic, or mechanical means.

As used herein, an “optocoupler” is an electronic device designed to transfer electrical signals by utilizing light waves to provide coupling with electrical isolation between its input and output, and may sometimes also be referred to as an opto-isolator, photocoupler, or optical isolator.

As used herein “mains power supply” refers to the general-purpose alternating current (AC) electric power supply from a public utility grid, which sometimes may also be referred to as household power, household electricity, domestic power, wall power, line power, city power, street power, and grid power.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a functional block diagram of one embodiment of a lighting arrangement that employs a dimmable lighting driver.

FIG. 2 is a functional block diagram of relevant portions of one embodiment of a lighting driver.

FIG. 3 is a functional block diagram of one embodiment of a dimmer interface for a dimmable lighting driver.

FIG. 4 is a schematic diagram of one embodiment of a dimmer interface for a dimmable lighting driver.

FIG. 5 is a schematic diagram of one embodiment of pulse width modulator for a dimmer interface.

### DETAILED DESCRIPTION

As explained above, there are situations where it is desirable or necessary to provide galvanic isolation between a dimmer control input and the rest of the dimmable lighting driver circuit. Applicants have recognized and appreciated that it would be beneficial to provide a dimmer interface for a lighting driver which can isolate a dimmer control input from the rest of the dimmable lighting driver circuit that may be exposed to high voltage (e.g., the driver's high voltage output stage and/or the driver's input stage, which is not isolated from mains power supply) without requiring a transformer for the dimming control input.

In view of the foregoing, various embodiments and implementations of the present invention are directed to a dimmer interface for a lighting driver, and a device including a lighting driver and a dimmer interface.

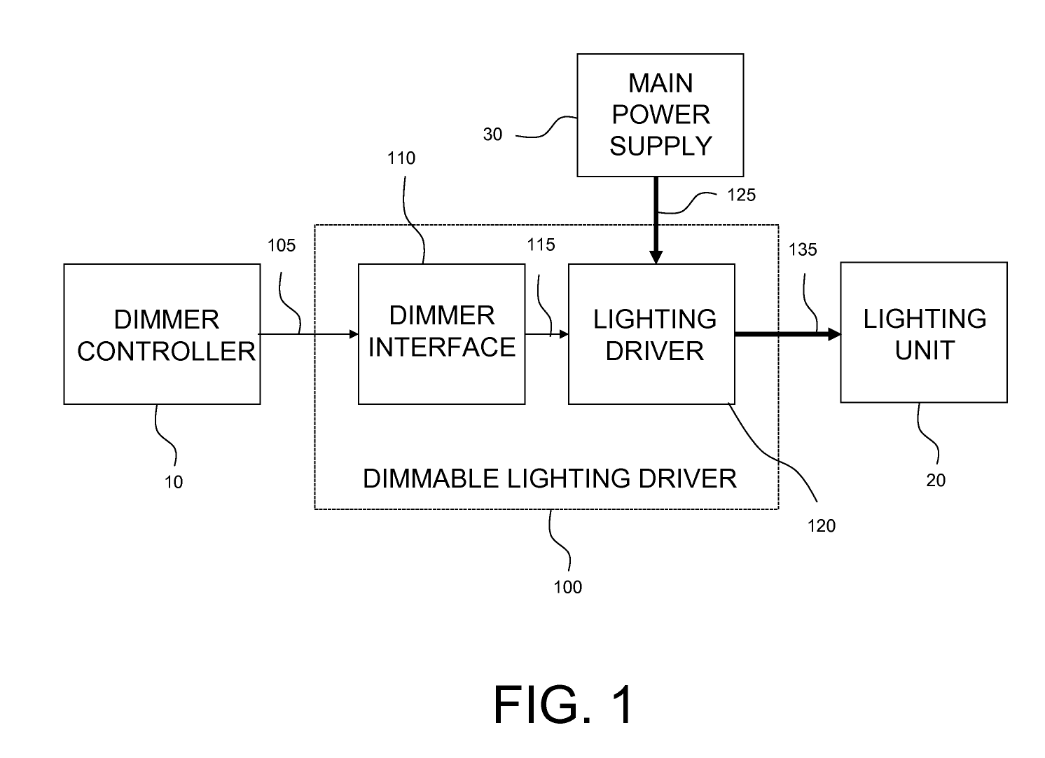

FIG. 1 is a functional block diagram of one embodiment of a lighting arrangement that employs a dimmable lighting driver 100. As shown in FIG. 1, dimmable lighting driver 100 includes a dimmer interface 110 and a lighting driver 120. In some embodiments, lighting driver 120 may include a lighting ballast, for example to supply power to one or more fluorescent lamps.

Dimmable lighting driver 100 is operationally connected to a dimmer controller 10, a main power supply 30, and a lighting unit 20. In various embodiments, dimmer controller 10 may include a user interface (e.g., a user-adjustable potentiometer) for a user to adjust or control a brightness of lighting unit 20. In various embodiments, lighting unit 20 may include one or more lamps, for example fluorescent lamps or light emitting diode (LED) lamps, such as one or more fluorescent tubes or fluorescent light bulbs or LED tubes or LED light bulbs. In various embodiments, main power supply 30 may include an AC power source, for example Mains power, and/or an emergency backup power source in case Mains power is lost.

Operationally, dimmer interface 110 receives from dimmer controller 10 an adjustable dimming control input 105 indicating an amount of dimming to be applied to lighting unit 120. In response to dimming control input 105, dimmer interface 110 supplies a dimming control voltage 115 to lighting driver 120. Lighting driver 120 also receives AC power 125 from main power supply 30 and processes dimming control voltage 115 and AC power 125 to produce an appropriate lamp power signal 135 for driving lighting unit 20. For example, in some embodiments where lighting unit 20 includes a fluorescent lamp, lighting driver 120 may include circuitry to preheat the fluorescent lamp, to apply a high voltage to the fluorescent lamp for ignition, and a ballast to maintain a desired current through the fluorescent lamp.

Beneficially, dimmer interface 110 provides galvanic isolation between dimmer controller 10 on the one hand, and main power supply 30 and lighting unit 20 on the other hand. That is, dimmer interface 110 galvanically isolates dimmer control input 105 from AC power 125 and from the lamp power signal and high voltages that may be generated by lighting driver 120.

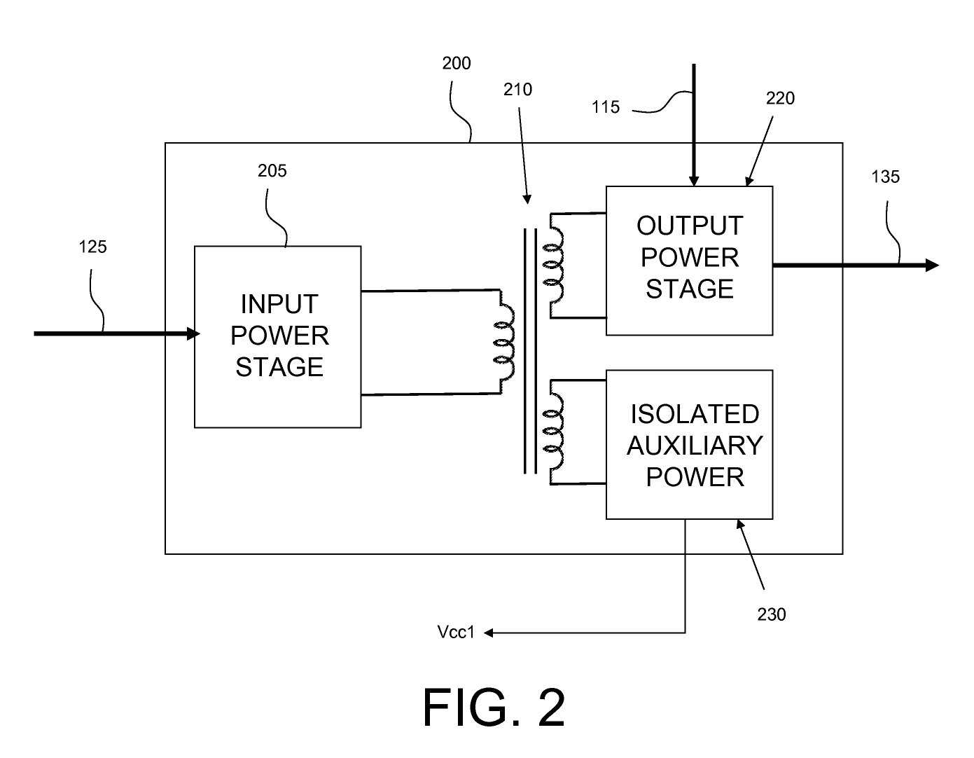

FIG. 2 is a functional block diagram of relevant portions of one embodiment of a lighting driver 200. Lighting driver 200 may be one embodiment of lighting driver 120 of dimmable lighting driver 100. Lighting driver 200 includes an input power stage 205, a power transformer 210, an output power stage 220, and an isolated auxiliary power block 230. Lamp driver 200 may also include other circuits or functional blocks not illustrated in FIG. 2.

In operation, input power stage 205 receives AC power 125 from an external main power supply, which in turn may receive power from Mains. Input power stage 205 processes the received power, which may include rectification, power factor correction, high frequency conversion, etc., and outputs the processed power to the primary winding of power transformer 210, which supplies power to output power stage 220 via a first secondary winding, and outputs a low AC voltage to auxiliary power block 230 on a second secondary winding. Output power stage 220 also receives dimming control voltage 115 and produces lamp power signal 135 for driving lighting unit 20. Isolated auxiliary power block 230 rectifies and low-pass filters the low AC voltage from power transformer 210 to generate a first DC supply voltage Vcc1 having a fixed voltage, for example, in a range of 10-12 volts. The first DC supply voltage Vcc1 is therefore galvanically isolated from both: (1) input power stage 205, AC power 125, and main power supply 30; and (2) output power stage 220 and lamp power signal 135, and may be provided to a dimmer interface such as dimmer interface 110 in FIG. 1, as will be explained in greater detail below.

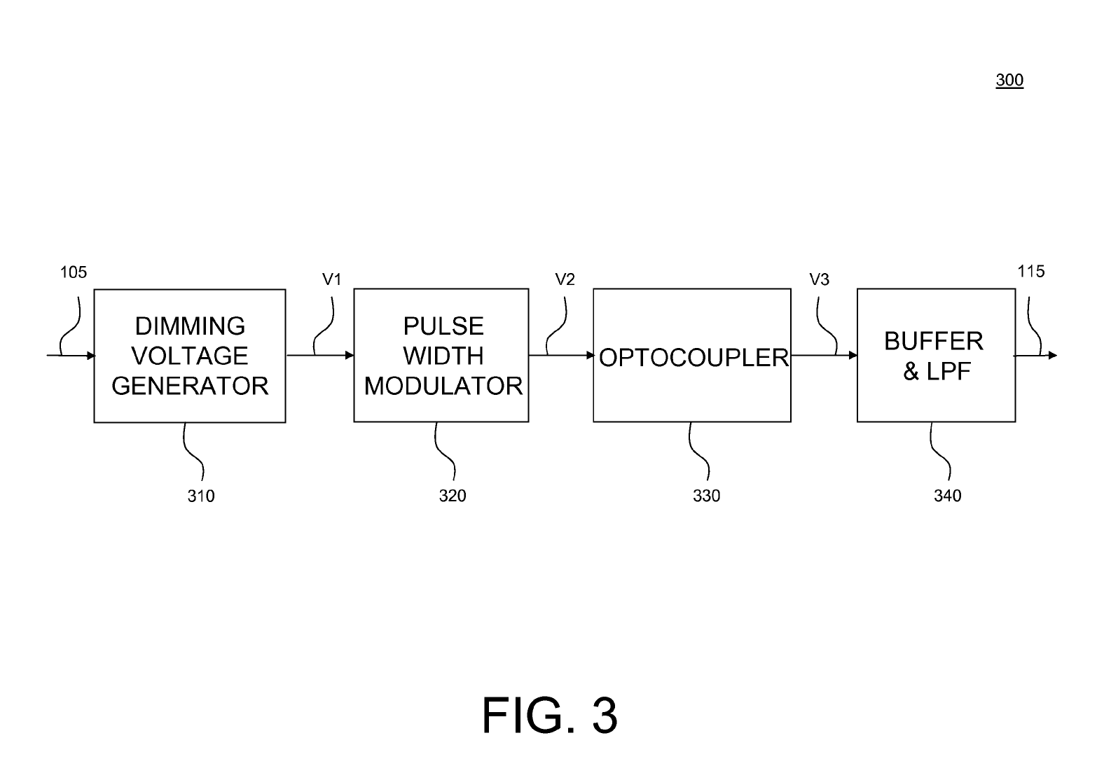

FIG. 3 is a functional block diagram of one embodiment of a dimmer interface 300 for a dimmable lighting driver. Dimmer interface 300 may be one embodiment of dimmer interface 110 of dimmable lighting driver 100. Dimmer interface 300 includes a dimming voltage generator 310, a pulse width modulator 320, an optocoupler 330 and a buffer and low-pass filter block 340.

Operationally, dimming voltage generator receives the adjustable dimming control input 105 indicating an amount of dimming to be applied to a lighting unit, and in response thereto generates a dimming voltage V1. Pulse width modulator 320 receives dimming voltage V1 and in response thereto to generate a pulse width modulated signal V2 having a duty cycle that is varied in response to the dimming voltage.

Optocoupler 330 receives pulse width modulated signal V2 and in response thereto outputs an isolated pulse width modulated signal V3 that is galvanically isolated from dimming voltage generator 310 and pulse width modulator 320.

Buffer and low-pass filter 340 buffers and averages the isolated pulse width modulated signal V3 to output dimming control voltage Vo 115.

Although not specifically illustrated in the functional block diagram of FIG. 3, beneficially dimming voltage generator 310 and pulse width modulator 320 operate with first DC supply voltage Vcc1, while buffer and low-pass filter block 340 operate with a second DC supply voltage Vcc2 that is galvanically isolated from first DC supply voltage Vcc1 such that dimming voltage generator 310 and pulse width modulator 320 are galvanically isolated from buffer and low-pass filter block 340.

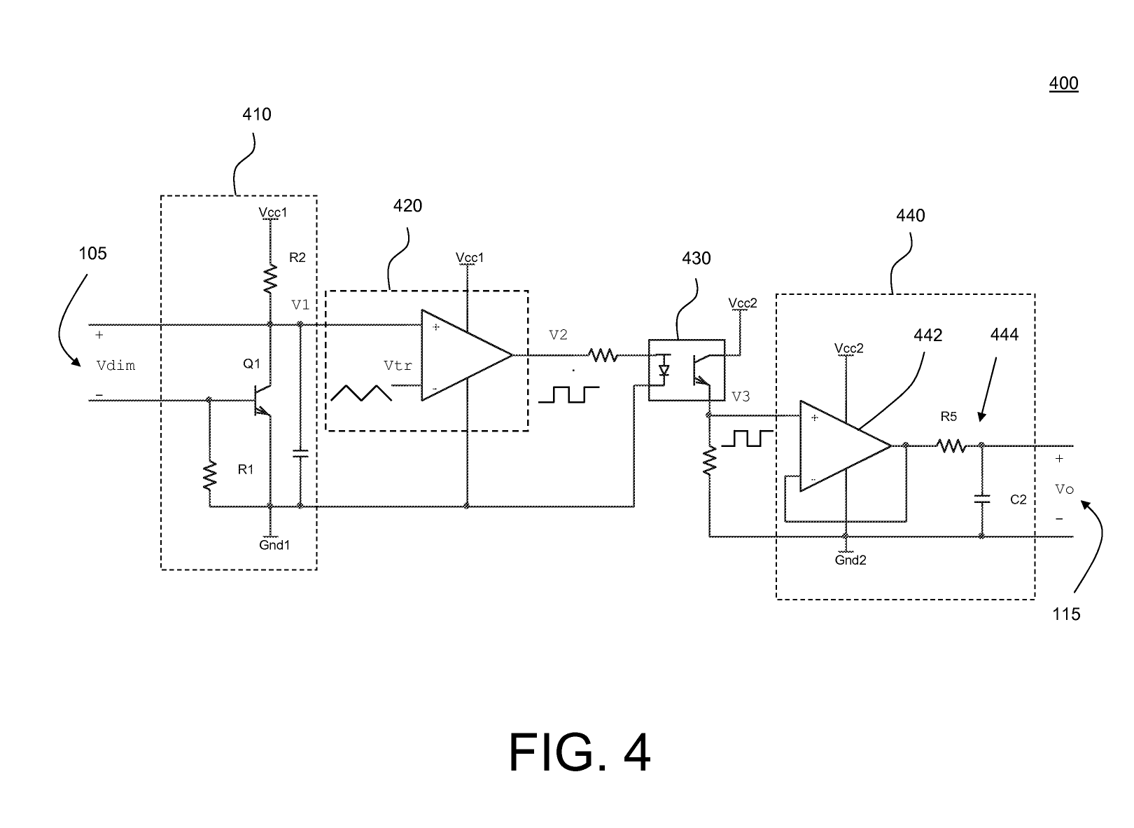

FIG. 4 is a schematic diagram of one embodiment of a dimmer interface 400 for a dimmable lighting driver. Dimmer interface 400 may be one embodiment of dimmer interface 110 of dimmable lighting driver 100 and an embodiment of dimmer interface 300 of FIG. 3. Dimmer interface 400 includes a dimming voltage generator 410, a pulse width modulator 420, an optocoupler 430 and a buffer and low-pass filter block 440.

Dimming voltage generator 410 includes transistor Q1 and biasing resistors R1 and R2, and operates with the first DC supply voltage Vcc1, which may be, for example, around 12V to accommodate a standard 0 to 10 V dimmer and minimize losses in the circuit.

Pulse width modulator 420 includes a triangle wave generator (not shown in FIG. 4) and a comparator, and operates with the first DC supply voltage Vcc1.

Optocoupler 430 includes a light emitter at its input side and a light detector at its output side and couples light from the light emitter to the light detector, with the light detector at the output side operating with the second DC supply voltage Vcc2 which may be produced at the secondary side of power transformer 210 by output power stage 220 of FIG. 2, for example as a power supply voltage for an output feedback compensation circuit for lighting unit 20.

Buffer and low-pass filter block 440 includes a buffer amplifier 442 operating with the second DC supply voltage Vcc2, and a low-pass filter 444 comprising resistor R5 and capacitor C2.

In operation, dimming voltage generator 410 receives a dimmer control input Vdim 105, which may be set for example by adjusting a potentiometer connected across the base and collector of Q1 to vary the bias voltage of V1, and outputs a dimming voltage V1. V1 can be written as:

V1=Vdim+Vbe (1)

where Vbe is the base-emitter voltage of Q1 and is roughly 0.7V for most of the NPN transistors, and dimmer control input Vdim is a zero or positive voltage set by an external control.

Pulse width modulator 420 receives the dimming voltage V1 and in response thereto generates the pulse width modulated signal V2. V2 is a duty ratio modulated unipolar square wave. Its frequency is determined by the implementation of the triangular waveform generator, its magnitude is roughly Vcc1, and the duty ratio is given by:

D=V1/Vth, when V1≦Vth, and

D=1, when V1>Vth (2)

where Vth is the peak voltage of the triangular wave, and the valley of the triangular waveform is assumed to be at 0V, which can be ensured by design of the triangular waveform generator, and 1/Vth is the gain of the pulse width modulator.

Optocoupler 430 receives the pulse width modulated signal V2 and couples the signal from its light emitter to its light detector to output an isolated pulse width modulated signal V3 that is galvanically isolated from dimming voltage generator 410 and pulse width modulator 420. V3 is a unipolar square wave having the same frequency and duty ratio D as V2, but having different magnitude:

V3_{MAG}=Vcc2−Vce (3)

where V3_{MAG} is the magnitude of V3 and Vce is the saturated collector-emitter voltage of the light detector of optocoupler 430 and may be, for example, about 0.2V.

Buffer amplifier 442 provides an impedance interface and transfers isolated pulse width modulated signal V3 to the input of the RC low-pass filter formed by R5 and C2. The dimming control voltage Vo is the average of the output of buffer amplifier 442 and can be written as:

Vo=DV3, (4)

From equations (1) through (4), dimming control voltage Vo can be written as:

Vo=(Vdim+Vbe)/Vth×(Vcc2−Vce), when V1≦Vth, and

Vo=(Vcc2−Vce), when V1>Vth (5)

In equation (5), Vbe and Vce are temperature dependent. However, since they are small in value and usually have small temperature coefficients, the temperature dependence of dimmer interface 400 is minor.

From equation (5), it can be seen dimming control voltage Vo is a linear function of dimming control input Vdim when dimming voltage V1 (=Vdim+Vbe) is less than Vth. When dimming voltage V1 is greater than Vth, then dimming control voltage Vo is saturated at the high limit set by Vcc2−Vce.

Pulse width modulator 420 can be implemented with a variety of embodiments.

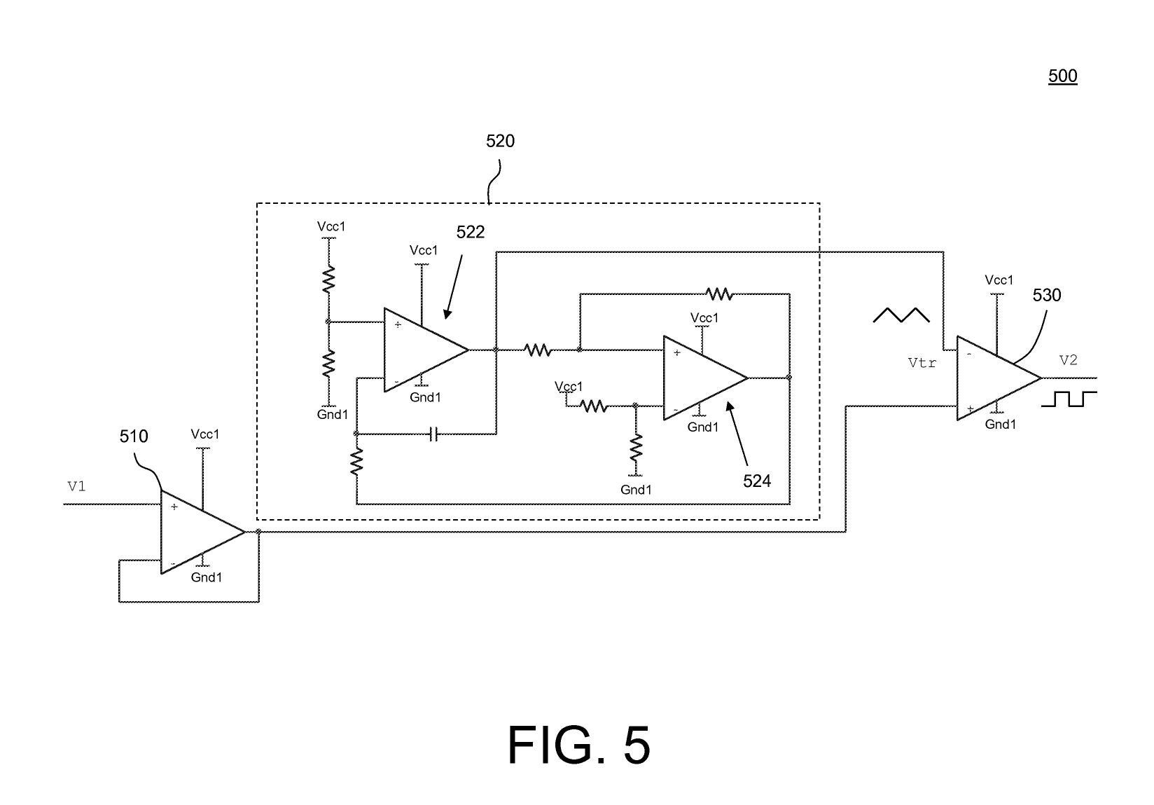

FIG. 5 is a schematic diagram of one embodiment of pulse width modulator 500 for a dimmer interface. Pulse width modulator 500 may be one embodiment of pulse width modulator 420 of dimmer interface 400 of FIG. 4. Pulse width modulator 500 includes a buffer amplifier 510 for buffering dimming voltage V1, a triangle wave generator 520 for generating a triangle wave Vtr, and a comparator 530 for comparing the dimming voltage V1 and the triangle wave Vtr to generate pulse width modulated signal V2. Triangle wave generator 520 includes first and second operational amplifiers 522 and 524 connected in a feedback configuration wherein an output of the first operational amplifier 522 is connected to an input of the second operational amplifier 524 and an output of the second operational amplifier 524 is connected to an input of the first operational amplifier 522.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The phrase “and/or,” as used herein in the specification and in the claims, should be understood to mean “either or both” of the elements so conjoined, i.e., elements that are conjunctively present in some cases and disjunctively present in other cases.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. It should also be understood that, unless clearly indicated to the contrary, in any methods claimed herein that include more than one step or act, the order of the steps or acts of the method is not necessarily limited to the order in which the steps or acts of the method are recited.

Any reference numerals or other characters, appearing between parentheses in the claims, are provided merely for convenience and are not intended to limit the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

What is claimed is:

1. An electronic device, comprising:
a dimming voltage generator configured to receive a dimming control input indicating an amount of dimming to be applied to a lighting unit, and being further configured in response to the dimming control input to generate a dimming voltage;
a pulse width modulator configured to receive the dimming voltage and in response thereto to generate a pulse width modulated signal having a duty cycle that is varied in response to the dimming voltage;
an optocoupler configured to receive the pulse width modulated signal and, in response thereto, to output an isolated pulse width modulated signal that is galvanically isolated from the dimming voltage generator and the pulse width modulator;
a low-pass filter configured to average the isolated pulse width modulated signal and to output a dimming control voltage; and
a lighting driver configured to receive the dimming control voltage and input power from an AC power source and, in response thereto, to supply power to the lighting unit, wherein the power supplied to the lighting unit is varied in response to the dimming control input.

2. The electronic device of claim 1, wherein the pulse width modulator comprises:
a triangle wave generator configured to generate a triangle wave; and
a comparator configured to compare the triangle wave and the dimming voltage and to generate the pulse width modulated signal in response to the comparison.

3. The electronic device of claim 2, wherein the triangle wave generator comprises first and second operational amplifiers connected in a feedback configuration wherein an output of the first operational amplifier is connected to an input of the second operational amplifier and an output of the second operational amplifier is connected to an input of the first operational amplifier.

4. The electronic device of claim 1, wherein the dimming voltage generator comprises a transistor whose bias voltage is varied in response to the dimming control input.

5. The electronic device of claim 1, further comprising a buffer amplifier configured to receive the isolated pulse width modulated signal and to buffer the isolated pulse width modulated signal for the low-pass filter.

6. The electronic device of claim 5, wherein the dimming voltage generator and the pulse width modulator operate with a first supply voltage, and wherein the buffer amplifier operates with a second supply voltage, wherein the first and second supply voltages are galvanically isolated from each other.

7. The electronic device of claim 6, wherein the lighting driver includes:
an input power stage configured to receive the input power from the AC power source; and
a transformer having at least first and second windings, and wherein the first winding is connected to an output of the input power stage and wherein the second winding is connected to a circuit for generating the first supply voltage.

8. The electronic device of claim 6, wherein the transformer includes a third winding connected to an output power stage for supplying the power to the lighting unit.

9. A method, comprising:
generating a pulse width modulated signal from a dimming control input, where the dimming control input is variable to adjust a brightness of a light source;
passing the pulse width modulated signal through an optocoupler; and
low-pass filtering an output signal of the optocoupler to produce a dimming control voltage for adjusting the brightness of the light source.

10. The method of claim 9, further comprising providing the dimming control voltage to a lighting driver for driving the light source.

11. The method of claim 9, wherein generating the pulse width modulated signal from the dimming control input includes:
generating a dimming voltage in response to the dimming control input;
generating a triangle wave; and
comparing the dimming voltage to the triangle wave to generate the pulse width modulated signal.

12. The method of claim 9, further comprising buffering the output signal of the optocoupler prior to low-pass filtering the output signal of the optocoupler.

13. A electronic device comprising:
a pulse width modulator configured to generate a pulse width modulated signal from a dimming control input, where the dimming control input (Vdim) is variable to adjust a brightness of a light source;
a low-pass filter configured to output a dimming control voltage (Vo); and
an optocoupler configured to couple the pulse width modulated signal (V2) from an output of the pulse width modulator to an input of the low-pass filter with galvanic isolation between the pulse width modulator and the low-pass filter.

14. The electronic device of claim 13, wherein the device is connected to a dimming controller and a lighting driver and provides galvanic isolation between the dimming controller and the lighting driver.

15. The electronic device of claim 13, further comprising a dimming voltage generator configured to receive the dimming control input and, in response thereto, to generate a dimming voltage; and
wherein the pulse width modulator comprises:
a triangle wave generator configured to generate a triangle wave; and
a comparator configured to compare the triangle wave and the dimming voltage and to generate the pulse width modulated signal in response to the comparison.

16. The device of claim 15, wherein the dimming voltage generator comprises a transistor whose bias voltage is varied in response to the dimming control input.

17. The device of claim 16, further comprising a buffer amplifier configured to buffer an output signal from the optocoupler for the low-pass filter, wherein the dimming voltage generator and the pulse width modulator operate with a first supply voltage, and wherein the buffer amplifier operates with a second supply voltage, wherein the first and second supply voltages are galvanically isolated from each other.

18. The device of claim 17, wherein the first supply voltage is generated from a transformer winding in a lighting driver which receives the dimming control voltage.
